(19) United States
(12) Patent Application Publication
(10) Pub. No.: US 2008/0015873 A1
(43) Pub. Date: Jan. 17, 2008

(54) System for Collecting Revenue for Rental Equipment

(75) Inventors: Ronald Shostack, Phoenix, AZ (US); Thomas Rosenbaum, Scottsdale, AZ (US)

Correspondence Address: VENABLE, CAMPILLO, LOGAN & MEANEY, P.C., 1938 E. OSBORN RD, PHOENIX, AZ, 85016-7234, US

(73) Assignee: COOLWELL, INC., Scottsdale, AZ (US)

(21) Appl. No.: 11/457,448

(22) Filed: Jul. 13, 2006

(51) Int. Cl. G06Q 10/00; G06Q 30/00

(52) U.S. Cl. 705/1

(57) ABSTRACT

A system and method for collecting revenue for the leasing of an apparatus. The system controls the availability of the apparatus by either: restricting use of the apparatus only if a timely lease payment has been made; making the apparatus available for use under the condition that the lessee of the apparatus has made timely payment; or a combination of thereof. The system utilizes a smart electronic data storage device to assist in debiting a lessee's account remotely via the Internet and allows leasing of the apparatus either for a given period of time or on a per-use basis.

### FIELD OF THE INVENTION

The present invention relates generally to a system and method for collecting revenue for the leasing of an apparatus. Specifically, the method pertains to a system for controlling the availability of the apparatus by either restricting use of the apparatus only if a timely lease payment has been made; making the apparatus available for use under the condition that the lessee of the apparatus has made timely payment; or a combination of thereof. The preferred method utilizes an electronic data storage device to assist in debiting a lessee's account remotely via the Internet and allows leasing of the apparatus either for a given period of time or on a per-use basis. Although the system may be incorporated for leasing various types of equipment, by way of one example the present invention discloses use in conjunction with the leasing of open-air golf cart air conditioners.

### BACKGROUND OF THE INVENTION

It is desirable in the business of leasing equipment to individuals and corporate entities to have an efficient and secure method for delivering and receiving payments. Of principal concern for the owner of the equipment is the assurance of payment. It is desirable for the equipment owner to regulate use of the equipment such that when a lessee fails to make a timely payment for use of the equipment, the equipment may be disabled from further use. It is also desirable for an equipment owner to lease equipment for a given period of time based upon advance payment such that at the conclusion of the rental period, the equipment will be disabled until further payment can be made. The present invention disclosed herein addresses all of the concerns described above and provides a system whereby a rental equipment owner can lease equipment to third parties and receive payment using various options and prohibit further use of the rental equipment until payment is made both remotely and securely through the Internet.

By way of illustrative example, open-air golf carts are often utilized in extreme temperatures. When golfers play during the hot temperatures of summer or in the cold temperatures of winter, it is desirable to maintain a comfortable environment while driving around a golf course. One approach to address the problem is by installing a portable air conditioner in the golf cart itself. In one instance, one or more portable air conditioners may be provided to a golf course and installed for use in its fleet of open-air carts. Rather than selling the units outright, the owner may prefer to lease the air conditioner units either directly to the golf course or to an individual golfer.

In the case where the golf course is the lessee, the lessor may prefer to rent the equipment on a per-use basis or for a given block of time. In the case of an individual golfer, it is likely that the rental period would be on a per-use basis only. Because the air conditioner units are usually secured permanently to the golf carts, and because not all golfers may wish to rent the air conditioner, securing rental payments becomes a more cumbersome task.

It is also understood that to a person of reasonable skill in the art that the underlying claimed invention can be utilized in other applications such as the leasing of coin operated appliances such as washers and dryers, vehicles, home electronics, or any other similar application.

### DISCUSSION OF THE PRIOR ART

Methods and devices used to disable equipment that is leased on a short-term basis are known in the prior art. More specifically, a pay-per-use rental scheme where the leased equipment is disabled absent timely payment is discussed in the prior art. Other similar portable air conditioning devices are disclosed in other U.S. patent.

In U.S. Pat. No. 6,061,668 issued to Sharrow, the inventor disclosed a pay-per-use system of collecting revenue for appliance rentals. However, the disclosure is limited to appliances used in the hospitality industry. Furthermore, it does not consider the situation where the equipment is provided from a first entity to a second entity and leased to a third entity in combination with the fact that the rental equipment may be highly mobile as in the case with vehicles or portable air conditioning units for golf carts.

In U.S. Pat. No. 6,356,881 issued to Milch et al, the inventor disclosed a pay-per-use system for collecting revenue from laundry equipment leased to a hotel toward the purchase of the equipment by the hotel. The disclosure does not consider the inherent problems with mobile equipment like that of the portable air conditioner unit and the security issues related to the mobility of the devices.

In U.S. Pat. No. 6,862,496 issued to Fukuoka et al, the inventor disclosed a device for transmitting information about the status of the laundry cycle to a third party and for charging the third party at the conclusion of the laundry cycle. Although the disclosure describes a method for debiting the third party's bank account, the disclosure does not consider the inherent problems with mobile equipment like that of the portable air conditioner unit and the security issues related to the mobility of the devices.

U.S. Pat. No. 6,917,853 and publication US2005/0166028 issued to Chirnomas disclosed a method for controlling leased or rented vending equipment. However, nothing in the Chirnomas disclosures disclosed a method for controlling equipment on a pay-per-use basis.

U.S. Pat. No. 6,624,744 issued to Wilson et al discloses a golf cart keyless control system that operates on a pay-per-use basis. Although this patent disclosed a system to limit the use of a golf cart to those individuals who have either paid for its use or must maintain the cart, it did not disclose the method employed in the present invention for prospective and retrospective billing for third party billing and the rental of third party equipment secured on golf carts.

### SUMMARY OF THE INVENTION

Broadly, it is an object of the present invention to provide a method to control an apparatus for the purpose of eliciting the payment of fees in exchange for use of the apparatus.

It is a further object of the present invention to provide a method to control an apparatus for the purpose of eliciting the payment of fees in exchange for the availability of use of the apparatus for a given period of time.

It is a further object of the present invention to provide a secure method of payment of fees remotely utilizing a portable electronic data storage device to store usage data so that the usage data may be transferred from a first location to a second location.

It is a further object of the present invention to remotely terminate use of an apparatus if payment is not received from the user of the apparatus in a timely fashion.

It is a further object of the present invention to provide a point of sale system wherein the system debits the user's bank account remotely via the Internet.

It is a further object of the present invention to utilize the system for remote payment and control of rental equipment such as a portable air conditioning unit for a golf cart.

It is a further object of the present invention to have the rental equipment contain a device for storing usage data for subsequent transmission to a remote location for further processing.

The description of the invention which follows, together with the accompanying drawings should not be construed as limiting the invention to the example shown and described, because those skilled in the art to which this invention appertains will be able to devise other forms thereof within the ambit of the appended claims.

### BRIEF DESCRIPTION OF THE DRAWINGS

FIG. 1 is a drawing that displays the system on a macroscopic level;

FIG. 2 is a detailed block diagram view of the computer server that controls the system;

FIG. 3 is a detailed block diagram view of a remote computer usually located at the lessee's premises;

FIG. 4 is a detailed view of a first remote location such as the golf course clubhouse on a golf course showing a computer connected via the internet to a computer at a second remote location;

FIG. 5 is a flowchart showing the method for collecting revenue using a prospective billing scheme;

FIG. 6 is a flowchart showing the method for collecting revenue using a retrospective billing scheme.

### DESCRIPTION OF THE PREFERRED EMBODIMENT

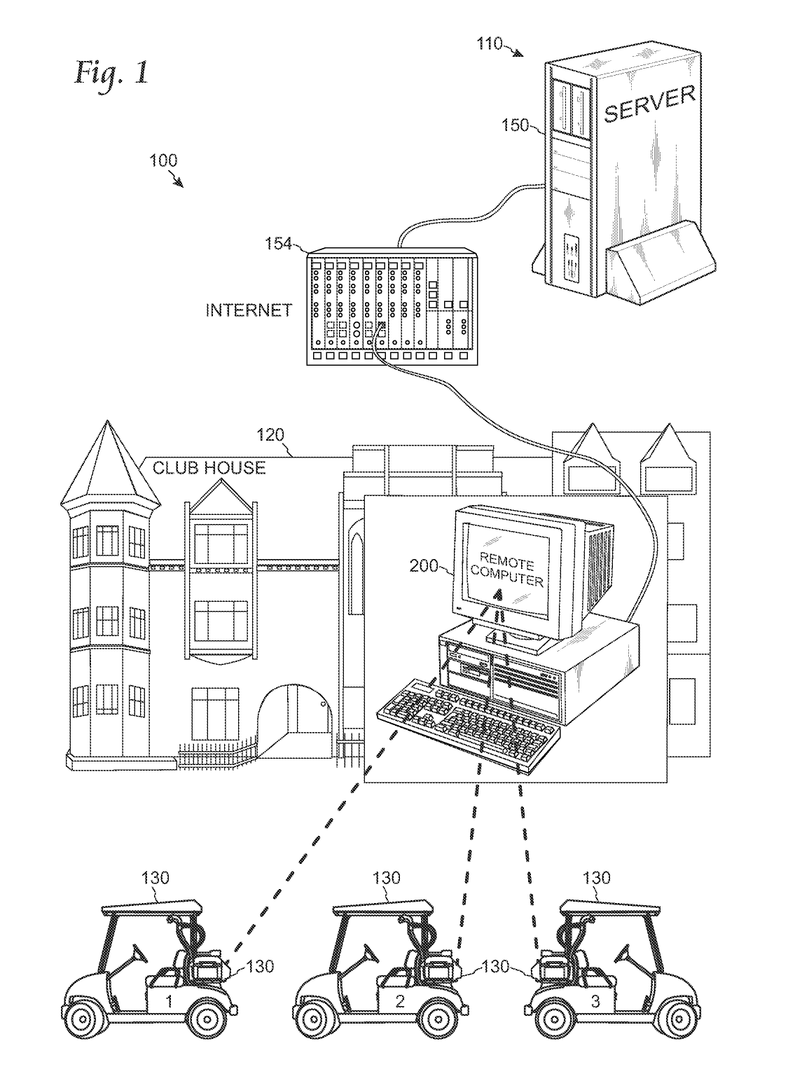

By way of one example of many to serve as background in understanding the present invention, FIG. 1 shows a macroscopic view of the invention 100. The system includes a first location such as a remote billing facility 110, a second location such as a golf course clubhouse 120 and a leased fleet of equipment such as open air golf cart air conditioners 130 that are secured to golf carts 140.

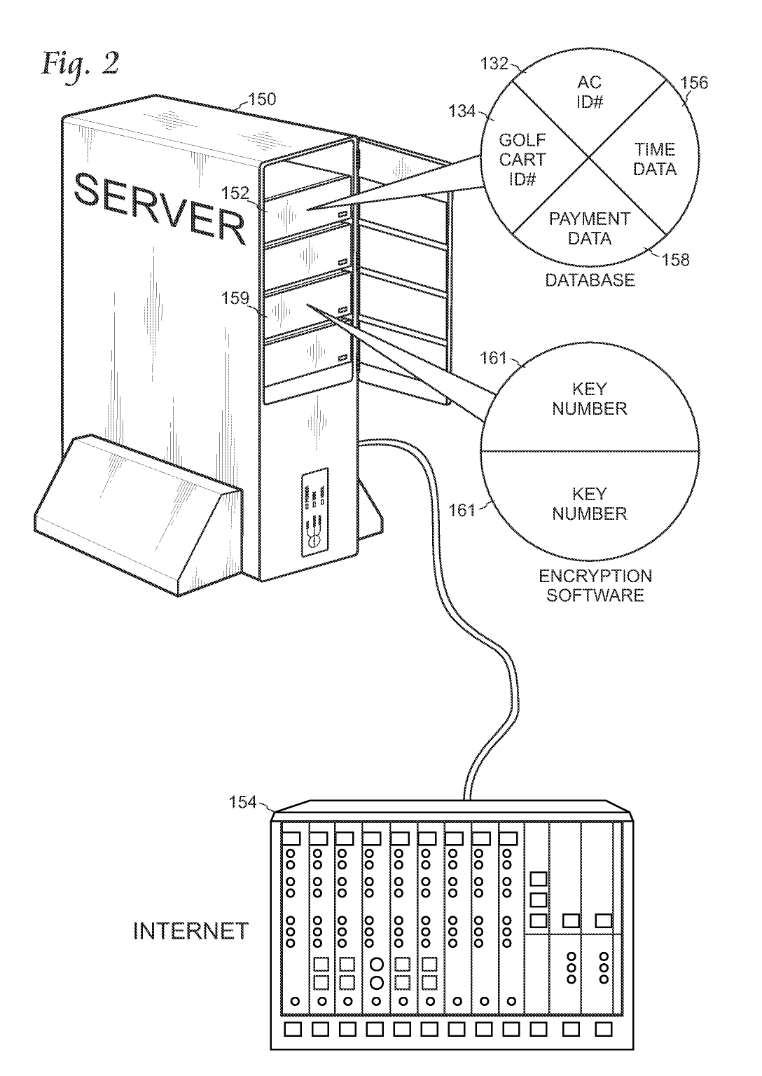

As shown in FIG. 1, the remote billing facility includes an Internet web server 150. A more detailed view of the server 150 is shown in FIG. 2. The server 150 utilizes a database 152 for storing data for all leased equipment such as the air conditioner 130 and is connected to the Internet 154. It is presumed that database 152 will store data for several air conditioners 130 that would be secured to several golf carts 140 at multiple golf course locations. The data stored in the database 152 includes the identification number 132 for each air conditioner 130 and for each identification number 132 an associated golf course identification number 134, a record of time 156 each air conditioner 130 has been in use, and payment history 158. The server 150 will also include a software program 159 for assigning an encrypted code key number 160. The key number 160 is used to validate and process payment information that originates from the clubhouse 120 and will be further described shortly. The server 150 is connected to the internet 154.

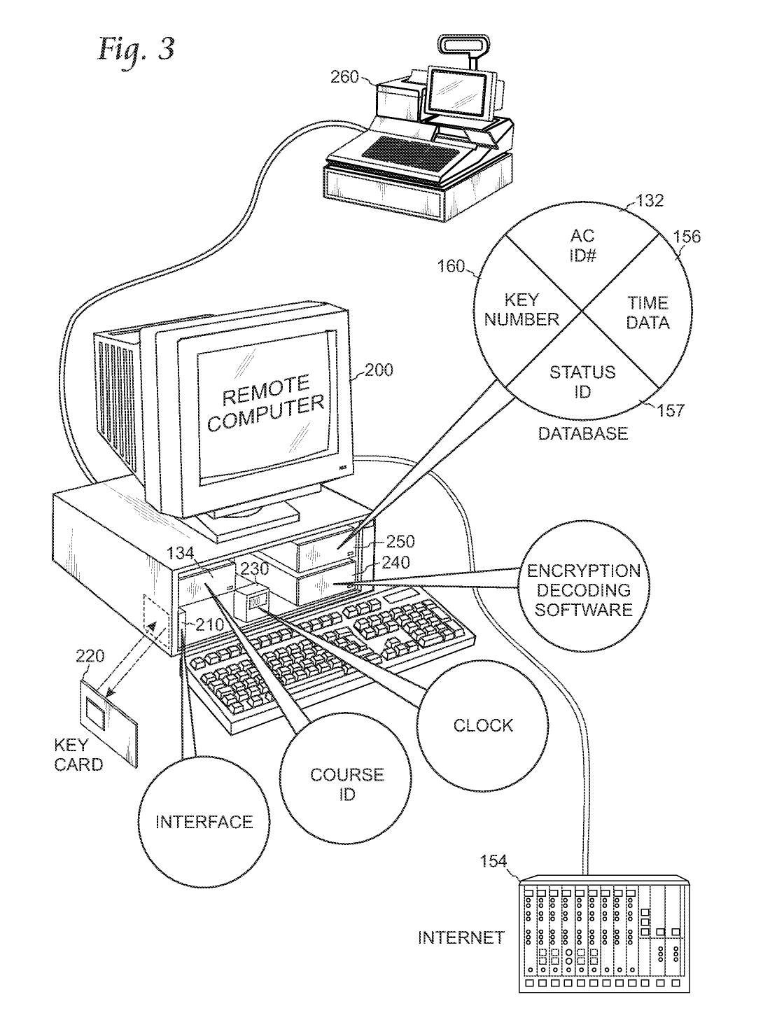

The clubhouse 120 includes a remote computer 200. A more detailed view of the remote computer 200 is shown in FIG. 3. The remote computer 200 includes at least one hardware interface 210 for communicating with an electronic data storage device 220 and a first real time clock 230. The computer 200 further includes software 240 for decrypting the encrypted code key number 160 generated by the software 159 on the server 150. The computer 200 contains a database 250 such that the database 250 is structured to include an air conditioner identification number 132 for each air conditioner 130, time of usage data 156 for both allowed time of usage and elapsed time of usage for each air conditioner unit 130, activation status 157 for each air conditioner 130, and the encrypted code key number 160 for each air conditioner unit 130. The computer 200 may also include, or interface with, a point-of-sale processing unit 260 for transacting payments for use of the air conditioner units 130.

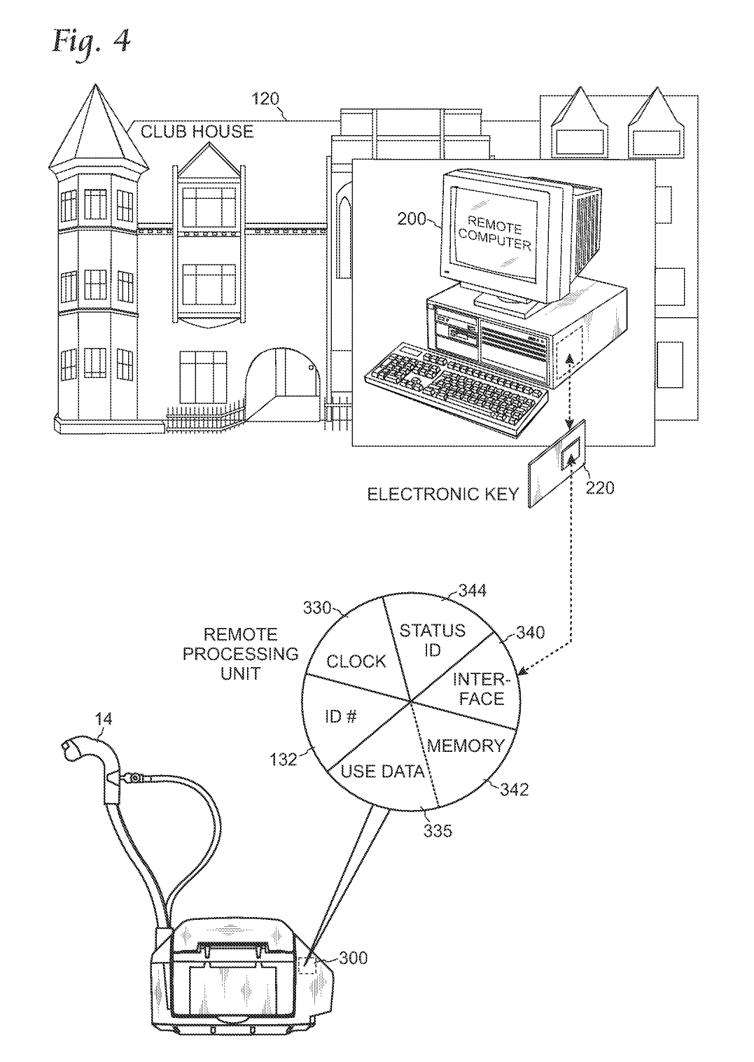

As shown in FIGS. 2 and 4, the air conditioner 130 includes a remote processing unit 300. FIG. 4 shows a detailed view of the processing unit 300. The unit 300 includes a second real time clock 330, a hardware interface 340 for communicating with the electronic data storage device 220, the air conditioner identification number 132, stored in electronic memory 342, and an activation status identifier 344 for the air conditioner 130. The second real time clock 330 is synchronized with the first real time clock 330 to ensure proper timing within the system.

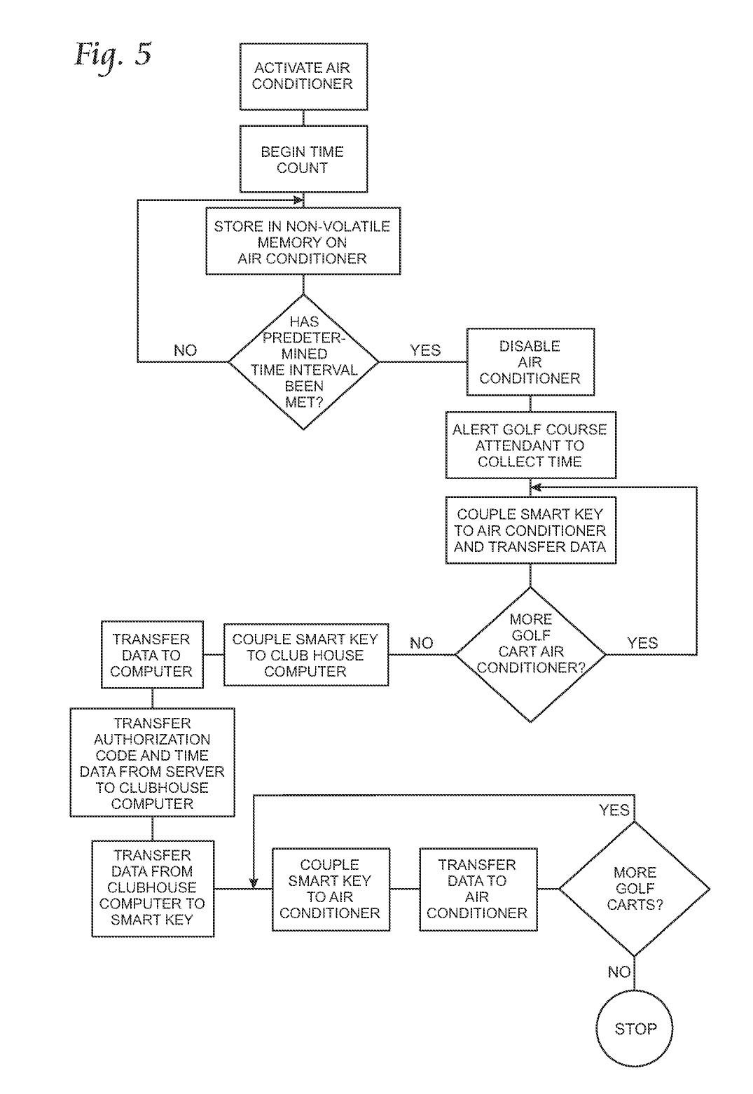

The mode of use referred to as the retrospective billing mode is simultaneously described in FIG. 5. The system allows the air conditioner 130 to operate for a distinct period of time. For the purpose of describing the preferred method of operation, it is presumed that the air conditioner 130 is has been previously activated such that the remote processing unit 300 indicates a time remaining status of thirty days. During the thirty-day period, the air conditioner 130 may be operated in conjunction with usage of the golf cart 140. At the conclusion of the thirty-day period, the golf cart 140 may still be used, however, the activation status identifier 157 in the remote processing unit 300 is set to “off” thereby terminating any further use of the air conditioner 130 until the status identifier 157 is reset to “on”.

The remote computer 200 will alert the clubhouse 120 that the air conditioner 130 is either inactive or is about to become inactive and that the accumulated hours must be collected and paid for in order to continue operation of the air conditioner 130. Once the time remaining in the remote processing unit 300 reaches zero, further use of the air conditioner 130 is precluded. An individual must place the electronic data storage device 220 near the hardware interface 330 so that the identification number 132 and the duration of use data 335 is transferred from the memory 342 of the remote processing unit 300 to the electronic data storage device 220. The data 335 can be encrypted for additional security. The electronic data storage device 220 is also presumed to have sufficient memory to collect data 335 from hundreds of air conditioners 130.

Once all of the data 335 from one or more air conditioners 130 has been acquired and stored on the electronic data storage device 220, the electronic data storage device 220 is placed near the hardware interface 210 of the remote computer 200 at the clubhouse 120. The data 335 from the electronic data storage device 220 is then transferred to the remote computer 200 which then calculates the total amount of time the air conditioner(s) 130 had been in use for a given time period. In order to secure the process, the remote computer 200 then generates and displays an encrypted code 160 that contains the golf course identification number 134 and usage data 335. Once the encrypted code 160 is obtained, an individual must access the Internet web server 150, preferably or most likely from the remote computer 200. Typically, this is done by logging into a website 151 through the Internet 154 that is maintained on the web server 150. Once accessed, the individual enters the encrypted code 160 along with payment information 158 such as a credit card or bank account number, into the website 151. The web server 150 then processes the transaction and issues a new encrypted number 161 that correlates to the golf course identification number 134 and provides the new usage data 335 for activating the air conditioner 130 for a specified period of time. The encrypted number 161 is then entered into the remote computer 200.

To reactivate the air conditioner 130, the electronic data storage device 220 is held near the second hardware interface 210 that is connected to the remote computer 200. The remote computer 200 transfers the usage data 335, corresponding golf course identification number 134 and the air conditioner identification number 132 to the electronic data storage device 220. Again, this information may be encrypted for security purposes. The electronic data storage device 220 is then held near one or more of the hardware interface(s) 210 on the remote processing units 300 on the air conditioners 130 that must be activated. The remote processing units 300 then extract the usage data 335, corresponding golf course identification number 134, and the air conditioner identification number 132 from the electronic data storage device 220. The activation status 344 of the air conditioner 130 is then switched to on.

In an alternative embodiment, the entire process of transmitting usage data 335 between the remote computer 200 and the remote processing unit 300 could be accomplished using a secure wireless transmission between the computer 200 and the unit 300.

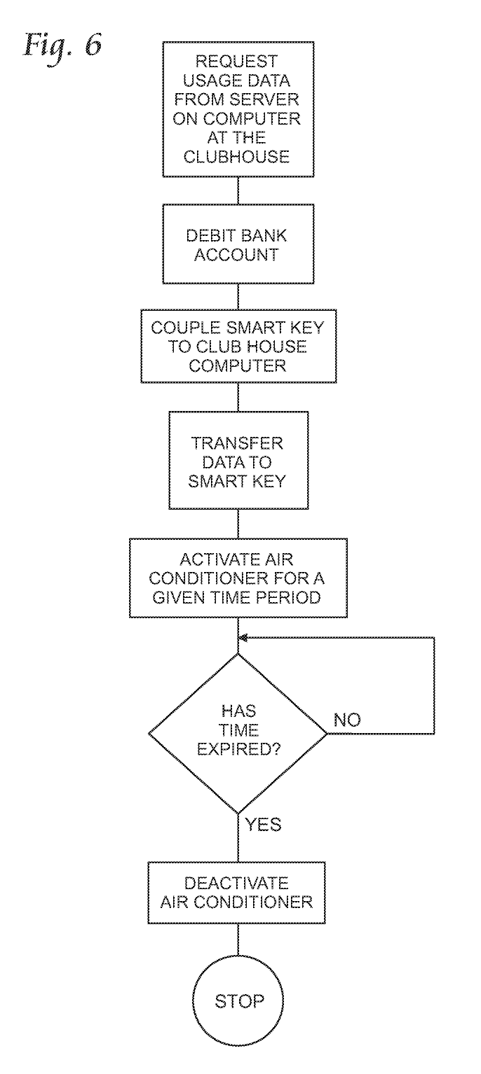

As shown in FIG. 6, when used in the Prospective Billing mode, the system allows the user to pay for the use of the air conditioner 130 at the clubhouse 120 and to activate the air conditioner 130 by using the electronic data storage device 220. The air conditioner 130 can be activated based upon an anticipated set amount of time or an absolute time such as a specific time of day. For implementing the prospective billing mode, the electronic data storage device 220 may contain at least the following data: golf course identification number 134, paid time data 156 or absolute time of day 156a, and an encryption key number 160. The remote processing unit 300 maintains a real time clock 330 which may keep track of relative or absolute time and date and unique air conditioner identification number 132.

The user activates the air conditioner 130 by placing the electronic data storage device 220 near the second hardware interface 210 of the remote processing unit 300. The remote processing unit 300 verifies that the encryption key number 160 is valid. If it is valid, the remote processing unit 300 extracts the time data 156.

If the air conditioner 130 is operating in the absolute time mode, the air conditioner unit 130 will remain active until the time of day contained in the electronic data storage device 220 has been removed. When the predetermined time of day is reached, the remote processing unit 300 deactivates the air conditioner 130 until new activation data is received from the electronic data storage device 220.

If the air conditioner 130 is operating in the “hours of use” mode, the air conditioner unit 130 will remain active for the discrete period of time contained in the electronic data storage device 220. When the predetermined time of use has elapsed, the remote processing unit 300 deactivates the air conditioner 130 until new activation data is received from the electronic data storage device 220.

While the inventive apparatus, as well as a method of cooling ambient air as described and claimed herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. An apparatus for obtaining revenue for leased equipment comprising:
a. a computer server;
b. a computer client;
c. at least one rental apparatus;
d. said computer server further comprising
i. a first database;
1. said first database further comprising data;
ii. a first hardware interface for transmitting said data from said computer server to said computer client;
e. said computer client further comprising
i. a second database for storing said data;
ii. a second hardware interface for transmitting and receiving said data from said second database to a remote location;
iii. a first real time clock;
f. said at least one rental apparatus further comprising
i. a data processing unit;
1. said data processing unit further comprising memory for storing:
a. said data; and
b. a rental apparatus identification code;
ii. a third hardware interface coupled to said data processing unit;
iii. a second real time clock coupled to said data processing unit;
iv. an electronic switch;
g. said computer server, said computer client, and said rental apparatus are electronically networked.

2. The apparatus as set forth in claim 1 further comprising a point of sale interface such that said interface is coupled to said computer client.

3. The apparatus as set forth in claim 1 such that said rental apparatus and said computer client are networked by means of the third hardware interface wherein said third hardware interface is a first wireless network adapter such that said first wireless network adapter may transmit and receive said data to said second hardware interface wherein said second hardware interface is a second wireless network adapter.

4. The apparatus as set forth in claim 1 wherein said data includes usage statistics for said at least one rental apparatus.

5. The apparatus as set forth in claim 1 further comprising a portable electronic data storage device wherein said portable electronic data storage device further comprises non-volatile memory for storing said data and such that said portable electronic data storage device enables the transmission of said data between said at least one rental apparatus and said computer client.

6. The apparatus as set forth in claim 5 wherein said second hardware interface of said computer client further comprises a first magnetic transceiver such that said first magnetic transceiver transmits and receives said data from said second database to said portable electronic data storage device if said portable electronic data storage device is coupled to said second hardware interface.

7. The apparatus as set forth in claim 5 wherein said third hardware interface of said at least one rental apparatus further comprises a second magnetic transceiver such that said second magnetic transceiver transmits and receives said data from said memory to said portable electronic data storage device if said portable electronic data storage device is coupled to said third hardware interface.

8. The apparatus as set forth in claim 1 wherein said electronic switch is set to an active or inactive state dependent upon the contents of said data such that when said electronic switch is set to the inactive state, said rental apparatus will no longer operate.

9. A method for collecting revenue for the leasing of an apparatus comprising the steps of:
a. determining if said apparatus has been active for a predetermined time interval through the use of a computer client;
b. deactivating said apparatus if said apparatus has been active for said predetermined time interval;
c. coupling a third hardware interface to a data processing unit on said apparatus;
d. coupling a second hardware interface to a computer client;
e. transferring data from memory through said third hardware interface to a second database through said second hardware interface such that said second database is coupled to said computer client;
f. transmitting said data to a server;
g. transmitting payment data from said server to said computer client;
h. submitting payment information corresponding to said data electronically from said computer client to said server;
i. computing a second predetermined time interval;
j. transmitting said second predetermined time interval from said server to said computer client;
k. transmitting said second predetermined time interval electronically from said computer client to said data processing unit on said apparatus;
l. activating said apparatus such that said apparatus may operate for a period of time no longer than said second predetermined time interval.

10. The method of claim 9 further comprising the step of transmitting an alert to said computer client from said data processing unit on said apparatus if said apparatus has been in an active state for said predetermined time interval.

11. The method of claim 9 wherein the step of deactivating said apparatus if said apparatus has been active for said predetermined time interval is done remotely.

12. The method of claim 9 wherein the method of transferring said data from said apparatus to said computer client further comprises the steps of:
a. coupling a portable electronic data storage device to said third hardware interface;
b. transferring said data from said apparatus through said third hardware interface to said portable electronic data storage device;
c. coupling said portable electronic data storage device to said second hardware interface;
d. transferring said data from said portable electronic data storage device to said second database through said second hardware interface.

13. The method of claim 9 wherein the step of step of transferring said second predetermined time interval electronically from said computer client to said data processing unit on said apparatus further comprises the steps of:
a. coupling said portable electronic data storage device to said second hardware interface such that said second predetermined time interval is transferred electronically from said computer client to said portable electronic data storage device; and
b. coupling said portable electronic data storage device to said third hardware interface such that said second predetermined time interval is transferred electronically from said portable electronic data storage device to said data processing unit.

14. The method of claim 12 wherein said transfer of said data from said second hardware interface to said portable electronic data storage device and the transfer of said data from said portable electronic data storage device to said third hardware interface is transferred through a magnetic interface.

15. The method of claim 13 wherein said transfer of said data from said second hardware interface to said portable electronic data storage device and the transfer of said data from said portable electronic data storage device to said third hardware interface is transferred through a magnetic interface.

16. A method for collecting revenue for the leasing of an apparatus comprising the steps of:
a. determining a first time interval corresponding to a length of time that said apparatus will be in an active state;
b. electronically transmitting a first data set to activate said apparatus for said first time interval from a computer client to a server;
c. transmitting a second data set from said server to said computer client such that said second data set corresponds to said first time interval;
d. submitting payment information corresponding to said first time interval electronically from said computer client to said server;
e. debiting a financial account in an amount corresponding to said first time interval;
f. transmitting said second data set from said computer client to said apparatus such that said apparatus is activated for said time interval as defined in said second data set.

17. The method of claim 16 wherein the transmission of said second data set from said computer client to said apparatus further comprises the steps of:
a. coupling a portable electronic data storage device to a second hardware interface in said computer client such that said data is transmitted from said computer client to said portable electronic data storage device;
b. coupling said portable electronic data storage device to a first hardware interface coupled to a data processing unit in said apparatus such that said data is transmitted from said portable electronic data storage device to said data processing unit.

18. The method of claim 17 wherein the transfer of said data from said second hardware interface to said portable electronic data storage device and the transfer of said data from said portable electronic data storage device to said first hardware interface is transferred magnetically.

19. The method of claim 16 wherein the submission of payment information is conducted via a point of sale apparatus coupled to said computer client.
